(19) United States
(12) Patent Application Publication
(10) Pub. No.: US 2020/0242526 A1
(43) Pub. Date: Jul. 30, 2020

(54) METHOD OF IMPROVING RISK ASSESSMENT AND SYSTEM THEREOF

(71) Applicant: Udbhata Technologies Private Ltd, Hyderabad (IN)

(72) Inventors: Anand Sampath, Hyderabad (IN); Srinivas Manem, Hyderabad (IN)

(73) Assignee: Udbhata Technologies Private Ltd, Hyderabad (IN)

(21) Appl. No.: 16/752,097

(22) Filed: Jan. 24, 2020

Related U.S. Application Data
(60) Provisional application No. 62/796,220, filed on Jan. 24, 2019.

(51) Int. Cl. G06Q 10/06; G06F 3/0483

(52) U.S. Cl. CPC G06Q 10/0635; G06F 3/0483; G06Q 10/06375; G06Q 10/06393

(57) ABSTRACT

Disclosed herein is a method and system for improving risk assessment for an enterprise. In one embodiment, the user selects one or more risk features and desired filter(s) to preview the risk analysis information of the organisation related to selected feature. Based on user selection, the system retrieves the relevant risk information comprising organization's proprietary internal information from proprietary data repository of the organization and related external peer or benchmark information from benchmark data repository coupled with the system. The system uses the retrieved information to determine an improved risk assessment thereby enhancing the relevance of the selected risk feature for decision making. The system further determines a reliability score for each improved risk assessment and displays a corresponding reliability indicator along with improved risk assessment, providing more confident to the determined risk assessment for effective risk-based decision making.

### CROSS REFERENCE TO RELATED APPLICATION

This application claims the benefit of priority to Provisional Patent Application under 35 U.S.C. § 119 to U.S. Provisional Patent Application Serial Number 62/796,220, filed on Jan. 24, 2019 and entitled “Risk Management Decision Support System And Method Thereof,” the contents of which are incorporated by reference herein in their entirety.

### TECHNICAL FIELD

The present subject matter is related, to risk assessment system in general and more particularly, but not exclusively related to method and system for enabling improved risk assessment in an enterprise risk management system in non-financial industry.

### BACKGROUND

Currently almost every organization or entity face various risks that create unexpected costs affecting their financial performance and reputation. Unmanaged risk is a great source of loss in the business and economy. The consequences of not being prepared for risk can have a damaging effect on the organization and the employees. As risks continue to increase, it is necessary for all the organizations to implement effective risk assessment and management systems that help organizations to appropriately assess the risk and enable managing the same to maximize opportunities.

Conventional methods of risk assessment and management enable the organizations to merely follow the general cycle of identifying risks, assessing and planning for the risk events, deploying and monitoring the solutions, and mitigating the risks. Some of the entities hire risk assessment experts or use rudimentary automated systems to collate, summarize and assess risk by collecting risk evidence from various parts of the entity and come up with risks associated with various assets, processes, people, products etc. Some of the existing risk management techniques focus on ways of automating the analysis of risk and identification of appropriate mitigating action for the identified risk. These risk management systems cannot adequately aid the user or the organization to assess the risk beyond a point. The existing risk management systems and solutions primarily use the proprietary information of the organization residing at the organization's repository and fail to consider much needed external perspectives. Also given the extensive and complex risk information, usually one cannot guarantee the reliability of the assessment report or advice generated by the system Further, the existing system requires more time to consider the external perspectives due to unavailability of convenient database storing all the required external perspectives and updating in real time basis, which is laborious, time consuming and prone to error. In the non-financial organizations, where the available risk information is largely qualitative and unstructured, it is even more desirous to have a method and system that effectively improves enterprise risk assessment and enable the authorized user to be confident about the risk assessment and overcoming the disadvantages and limitations of the existing systems.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of improving the risk assessment process for an enterprise. The method includes receiving a selection of at least one risk feature interface along with one or more input search criteria associated with the selected risk feature interface as input from the user. The method comprises retrieving proprietary risk information or benchmark and/or peer risk information or both as per the selected risk feature interfaces corresponding to the one or more search criteria and in the latter case, simultaneously superimposing benchmark and/or peer risk information onto proprietary risk information for determining the risk assessment The method further comprises contemporaneously displaying the information for improved risk assessment.

Further, the disclosure relates to a system for improving risk assessment for an enterprise. The system comprises a processor, one or more risk feature interfaces and a user device, coupled with the processor. The system further comprises a memory communicatively coupled with the processor, wherein the memory stores processor-executable instructions, which, on execution, cause the processor to receive a selection of at least one risk feature interface along with one or more input search criteria associated with the selected risk feature interfaces as a input from the user device. The processor is configured to retrieve proprietary risk information or b) benchmark and/or peer risk information or both as per the selected risk feature interfaces and one or more search criteria corresponding to the risk feature interfaces. The processor further superimposes benchmark and/or peer risk information onto proprietary risk information simultaneously for determining the improved risk assessment. The processor further contemporaneously displays the improved risk assessment based on the superimposition.

Furthermore, the present disclosure relates to a non-transitory computer readable medium including instructions stored thereon that when processed by at least one processor cause a system to receive a selection of at least one risk feature interface along with one or more input search criteria associated with the selected risk feature interfaces as input from the user. Further, the instructions cause the processor to retrieve proprietary risk information or benchmark and/or peer risk information or both as per the selected risk feature interfaces and one or more search criteria. Furthermore, the instructions cause the processor to simultaneously superimpose benchmark and/or peer risk information onto proprietary risk information for determining the improved risk assessment. Further, the instructions cause the processor to contemporaneously display the improved risk assessment and a respective reliability indicator derived from generated reliability score on the user device.

The foregoing summary is illustrative only and is not intended to be in anyway limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A illustrates an exemplary architecture of a proposed system to improve risk assessment for an enterprise in accordance with some embodiments of the present disclosure;

FIG. 1B depicts an exemplary representation of a client data management module in accordance with some embodiments of the present disclosure;

FIG. 1C depicts an exemplary representation of an external data management module in accordance with some embodiments of the present disclosure;

FIG. 1D illustrates an exemplary representation of interaction of external data management module with various data sources/data management systems in accordance with an embodiment of the present disclosure;

FIG. 2 illustrates an exemplary block diagram of a system for improving risk assessment in accordance with an embodiment of the present disclosure;

FIG. 3 illustrates an exemplary representation of interaction of various components of the proposed risk assessment system in accordance with an embodiment of the present disclosure;

FIG. 4 illustrates a high-level architecture illustrating the interaction of risk management client application with one or more components of client data management module and interaction of risk management master application with one or more components of external data management module supported by the system for improving risk assessment in accordance with some embodiments of the present disclosure;

FIG. 5 illustrates an exemplary representation of reliability scoring module in accordance with an embodiment of the present disclosure;

FIG. 6 illustrates a flowchart showing a method of improving risk assessment for an enterprise in accordance with some embodiments of the present disclosure;

FIG. 7A illustrates a flowchart illustrating a method of defining parameters, rating and weightage for the defined parameters for an enterprise in accordance with some embodiments of the present disclosure;

FIG. 7B illustrates a flowchart showing a method of determining reliability score of the improved risk assessment for an enterprise in accordance with some embodiments of the present disclosure;

FIG. 8 illustrates an exemplary illustration of calculating reliability score in accordance with an embodiment of the present disclosure;

FIGS. 9A-9C illustrate an exemplary representation of the improved risk assessment of various risk feature interfaces in accordance with an embodiment of the present disclosure; and

FIG. 10 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “include(s)”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

Embodiments of the present disclosure relates to a method and system for improving risk assessment for an enterprise risk management system of non-financial companies. An authorized user of the enterprise interacts with the system for determination of risk assessment via a user device. The system identifies role of the user and displays relevant risk information based on the role of the user on display screen of the user device. The system is configured to provide at least one risk feature interface wherein each risk feature interface is a unique representation of risk assessment information for the enterprise. In one embodiment, the user selects at least one risk feature interface and provides desired filters as input to preview the desired risk assessment information of the enterprise based on the filters. Based on the user input, the system retrieves the related risk information from a proprietary data repository of the enterprise maintained internal to the organization, and if applicable, simultaneously from an external benchmark and peer data repository accessible by the organization. The system superimposes the peer and/or benchmark information over the retrieved proprietary information and determines the risk assessment for each selection of risk feature interface. Further, the system also determines a reliability score indicative of how confident the determined risk assessment can be relied upon and displays the risk assessment along with a reliability score in relevant format. The ability of the system to provide reliability score for various risk feature interfaces enables the authorized person of the enterprise to be more confident on the improved risk assessment of the enterprise. Also, the intelligence of the system to use combination of proprietary risk information and external benchmark and peer information enhances the quality of the risk assessment thus determined.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

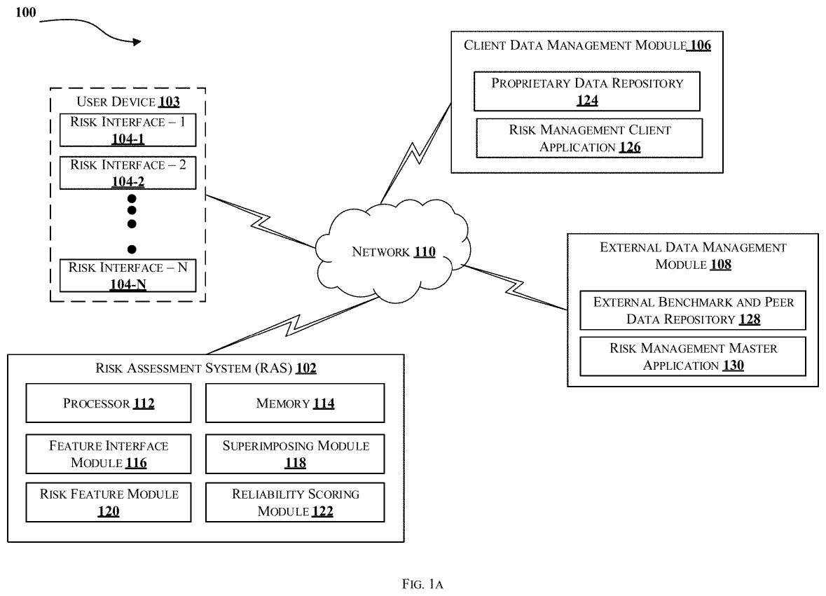

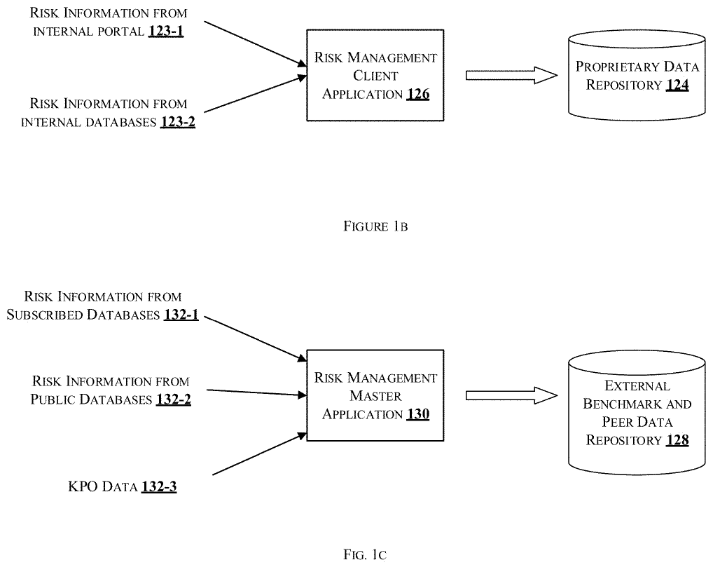

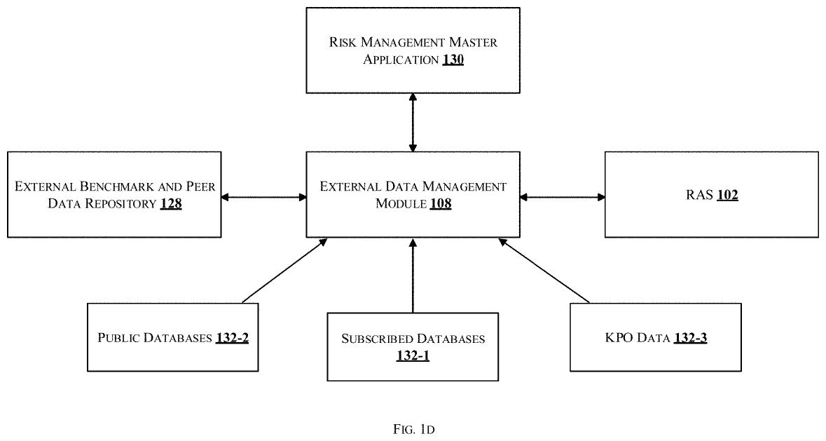

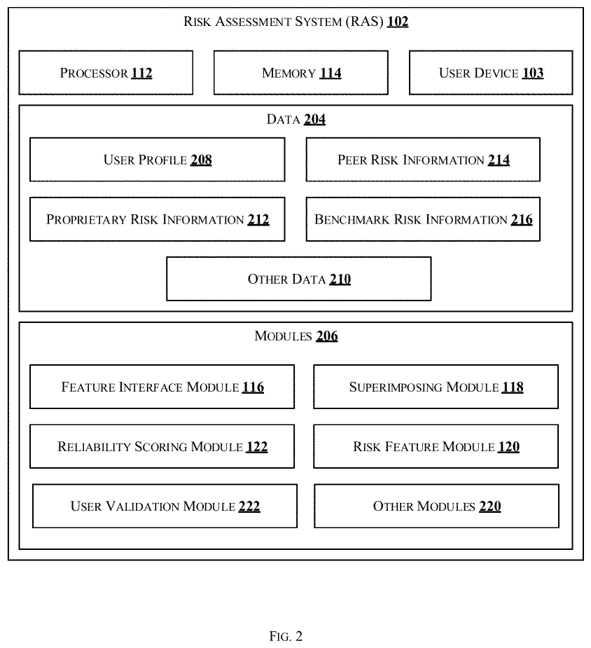

FIG. 1a illustrates an exemplary architecture of a proposed system (100) for improving risk assessment of an enterprise in accordance with some embodiments of the present disclosure.

As shown in FIG. 1a, the exemplary system (100) comprises one or more components configured for improving risk assessment of an enterprise. In one embodiment, the system (100) comprises a risk assessment system (hereinafter referred to as RAS) (102), a user device (103) comprising one or more risk feature interfaces 104-1, . . . N (hereinafter collectively referred to as risk feature interface 104), a client data management module (106), and an external data management module (108) communicatively coupled via a communication network (hereinafter referred to as network 110). The network (110) may include, without limitation, a direct interconnection, LAN (local area network), WAN (wide area network), wireless network, point-to-point network, or another configuration. One of the most common types of network in current use is a TCP/IP (Transfer Control Protocol and Internet Protocol) network for communication between database client and database server. Other common Internet protocols used for such communication include HTTPS, FTP, AFS, and WAP and other secure communication protocols etc.

The RAS (102) assesses the risk of an enterprise based on the proprietary risk information maintained internal to the organization, and benchmark and peer risk information maintained external to the organization. In one embodiment, the RAS (102) comprises a processor (112), a memory (114), a feature interface module (112), a superimposing module (118), a risk feature module (120) and a reliability scoring module (122). The user device (103) is coupled with the processor (112) and the memory (114) via the network (110). The RAS (102) further provides the improved risk assessment and reliability score of the improved risk assessment to the user via the user device (103). The user device (103) may be a mobile device or a computing device including the functionality for communicating over the network (110). For example, the user device can be a conventional web-enabled personal computer in the home, mobile computer (laptop, notebook or subnotebook), Smart Phone (iOS, Android & Windows), personal digital assistant, wireless electronic mail device, tablet computer or other device capable of communicating both ways over the Internet or other appropriate communications network.

The client data management module (106) may be a client-side enterprise system that manages and updates the risk information of an enterprise. In one embodiment, the client data management module (106) is internal to the enterprise or organization that is configured to retrieve or collect all the risk information and proprietary risk information of the enterprise related to various risk categories from one or more internal portals or internal database of the enterprise. Examples of the several proprietary risk information include particulars of risks, impact of risks, mitigation plan, key risk indicators (KRI) for specific risks etc. The various risk categories may be Human resources (HR) risk, projects risk, supply chain risk and so on. The client data management module (106) may store the retrieved enterprise risk information in an internal memory of the client data management module (106). The client data management module (106) facilitates at least one user of an authorized team or data management team of the enterprise to define and update proprietary risk information of the enterprise for each risk category using the retrieved enterprise risk information (123-1, 123-2) and store the proprietary risk information in a proprietary data repository (124) by using a risk management client application (126) as illustrated in FIG. 1B. In one embodiment, the proprietary data repository (124) may be integrated within the client data management module (106). The client data management module (106) may be configured, for example, as a standalone system. In another example, the client data management module (106) may be configured in cloud environment. In yet another example, the client data management module (106) may include a desktop personal computer, workstation, laptop, PDA, cell phone, or any WAP-enabled device or any other computing device capable of interfacing directly or indirectly to the Internet or other network connection. In one embodiment, the risk management client application (126) may be embedded in any mobile device or computing device including the functionality for communicating over the network (110). The authorized team or data management team of the enterprise may update the proprietary data repository (124) with multiple data records of risk information from one or more internal portals or internal database (123-1, 123-2) of the enterprise using risk management client application (126).

The external data management module (108) enables the authorized owners of RAS (102) to manage data population and updates to an external risk, benchmark and peer data repository (128), maintained external to the enterprise, by using a risk management master application (130). The external data management module (108) is configured to retrieve unstructured risk information from various data sources such as subscribed databases (132-1), public databases (132-2), and input data from KPO (132-3) as illustrated in FIG. 1C. The subscribed databases (132-1) may be licensed databases that provide information related to risks of various peer enterprises and reports illustrating the risk analysis. The open databases or public databases (132-2) may be the free data sources such as internet, e-journals, news reports, analyst reports, investor call transcripts, annual reports of peer companies etc. that provides the risk related information across the industries. In one example, the Knowledge Process Organization (KPO) provides the external risk information (132-3) along with a data rating where the KPO manually analyses the external information and determines a data rating according to the information quality of the external risk information. The external data management module (108) stores the unstructured risk information collected from the subscribed databases (132-1), the publicly available databases (132-2), and input data from KPO (132-3) in internal memory of the external data management module (108). The external data management module (108) enables the authorized owners of the RAS(102) to organize the collected unstructured information, define structured benchmark and/or peer risk information for each risk category and store the benchmark and/or peer risk information along with the data rating in the external benchmark and peer data repository (128) via the risk management master application (130). The data rating of the benchmark and/or peer risk information enables the RAS (102) to push the highly rated data at the time of superimposition. In one embodiment, the risk management master application (130) may be embedded in any mobile device or computing device including the functionality for communicating over the network (110). The authorized owners or data management team of the RAS (102) may update the external benchmark and peer data repository (128) with multiple data records of risk information using external data management module (108). Each data record may be associated with source of data record from where the data is obtained, quality of data record and so on. In one embodiment, the external data management module (108) can automatically convert the unstructured information collected from multiple data sources to structured risk information for each risk category. In one example, the external benchmark and peer data repository (128) may be integrated within the external data management module (108). The external data management module (108) may be configured, for example, as a standalone system. In another example, the external data management module (108) may be configured in cloud environment. In yet another example, the external data management module (108) may be integrated within the RAS (102).

FIG. 1D illustrates the representation of interactions of external data management module with various data sources/data management modules.

The user device (103) may be a mobile device or a computing device including the functionality for communicating over the network (110). The user device (103) enables the users for example, an authorized user of enterprise or organization to interact with the RAS (102) to inquire about the risk of the enterprise. For example, the user device (103) is configured to display at least one risk feature interface (104) and the user may select the risk feature interface (104) with desired filter to preview desired risk assessment outcome. Each risk feature interface (104) corresponds to a unique representation of improved risk assessment of the enterprise based on determined combination of risk information of the enterprise.

The external benchmark and peer data repository (128) comprise benchmark information related to various risks associated with plurality of peer enterprises. In one embodiment, the benchmark information includes risk information of multiple organizations of various industries. In another embodiment, benchmark information includes target risk information that is benchmark to the industry. The benchmark information may be stored as risk information per industry per organization per risk type. The benchmark information may also include risk information that is benchmark to a specific country. The benchmark information may be collected from various publicly available databases and from the paid/subscribed databases. For example, the benchmark information for a pharma company will be the risk information of one or more peer or competitor companies of the corresponding pharma company along with risk information of the same pharma company that is available in public. In one example, the external benchmark and peer data repository (128) may be integrated within the external data management module (108). In another example, the external benchmark and peer data repository (128) may be configured independent of the external data management module (108) and communicatively connected via the network (110). In yet another example, the external benchmark and peer data repository (128) may be a repository or database hosted in an external cloud server (not shown).

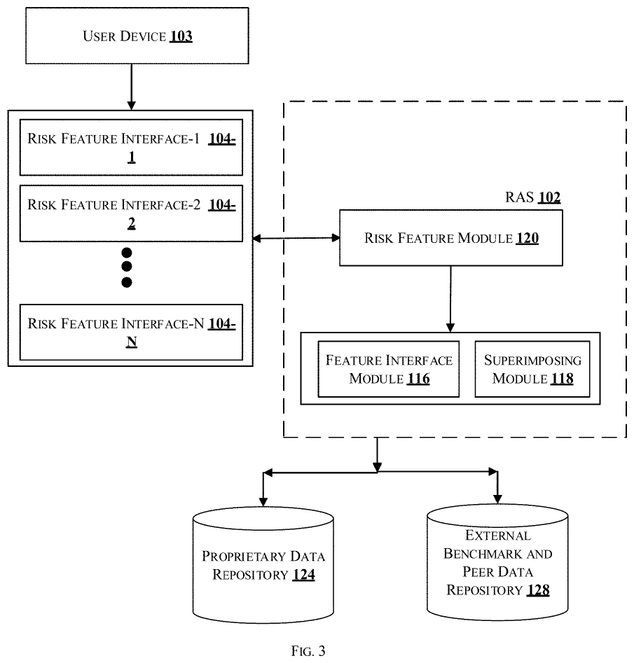

The RAS (102) may be configured in cloud environment. In one embodiment, the RAS (102) may be configured as standalone system. In another embodiment, the RAS (102) may be a typical risk management system as illustrated in FIG. 2. The RAS (102) comprises the processor (112) and the memory (114). The user device (103) is coupled with the processor (112) and the memory (114) via the network (110). The user device (103) is configured to display one or more risk feature interfaces, receive inputs from the user and transmit outputs to the user for displaying the improved risk assessment information based on the role of the user and reliability score. The user device (103) may be configured to receive user selections required for customization of risk feature interfaces and display improved risk assessment of the organization.

The RAS (102) further includes data (204) and modules (206). In one implementation, the data (204) can be stored within the memory (114). In one example, the data (204) may include user profiles (208), proprietary risk information (212), peer risk information (214), benchmark risk information (216), and other data (210). In one embodiment, the data (204) can be stored in the memory (114) in the form of various data structures. Additionally, the aforementioned data can be organized using data models, such as relational or hierarchical data models. The other data (210) may be also referred to as reference repository for storing recommended implementation approaches as reference data. The other data (210) may also store other internal and external data, including temporary data, temporary files, defined weightage and range rating of the defined parameters, risk assessment outcome, and reliability score generated by the modules (206) for performing the various functions of the RAS (102).

The modules (206) may include, for example, the feature interface module (116), the superimposing module (118), the risk feature module (120), the reliability scoring module (122), a user validation module (222). The modules (206) may also comprise other modules (220) to perform various miscellaneous functionalities of the RAS (102). It will be appreciated that such aforementioned modules may be represented as a single module or a combination of different modules. The modules (206) may be implemented in the form of software performed by the processor, hardware and/or firmware.

In operation, an authorized user of the enterprise may login into the RAS (102) for determining risk assessment of a particular business of the enterprise. The user validation module (222) validates the user based on the user profile (208) data stored previously and determine the role of the user in the enterprise. The feature interface module (116) is configured to display the risk feature interfaces (104) and receives user selection of the risk feature interface (104) for display of the selected risk feature interface (104) on the user device (103). Further, the feature interface module (116) is configured to enable the user to define different search criteria for risk assessment and navigate from the improved risk assessment of one risk feature interface (104) to another based on user selection of risk feature interface (104).

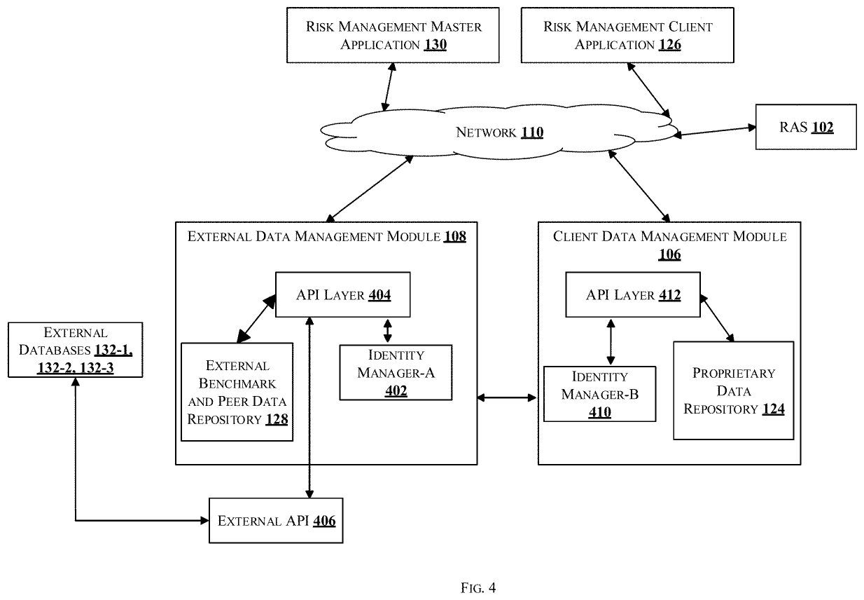

As illustrated in FIG. 3, the user device (103) enables the authorized user of the enterprise to interact with the RAS (102). The RAS (102) displays one or more default risk feature interfaces such as risk feature interface-1 (104-1), risk feature interface-2 (104-2), . . . risk feature interface-N (104-N) on the display screen of the user device (103) as illustrated.

The user may select one or more risk feature interfaces (104) displayed on the user device (103) and the user may further provide one or more search criteria to receive different preview of the risk assessment. In one embodiment, for the selected risk feature interface (104), the RAS (102) comprises the risk feature module (120) configured to perform functionalities of the superimposing module (116) and the feature interface module (116). In one example, the RAS (102) comprises the risk feature module (120) configured to get activated when the one of the risk feature interface i.e., risk feature interface-1 (104-1), risk feature interface-2 (104-2), risk feature interface-N (104-N) is selected by the user. Upon activation, the risk feature module (120) retrieves proprietary risk information from the proprietary data repository (124) based on the one or more search criteria, and if required based on the risk feature interface (104), enables the superimposing module (118) to retrieve the benchmark information and peer risk information from the external benchmark and peer data repository (128) relevant to the corresponding risk feature interface (104) based on the one or more search criteria for superimposition. As an example, the user can avail all the risk feature interfaces (104) in the respective user device (103), however user can receive the improved risk assessment data relevant to the role of the user i.e. the head of one business unit may not be able to view the information pertaining to the other business units of the enterprise. Thus, an additional restriction is imposed while displaying the improved risk assessment.

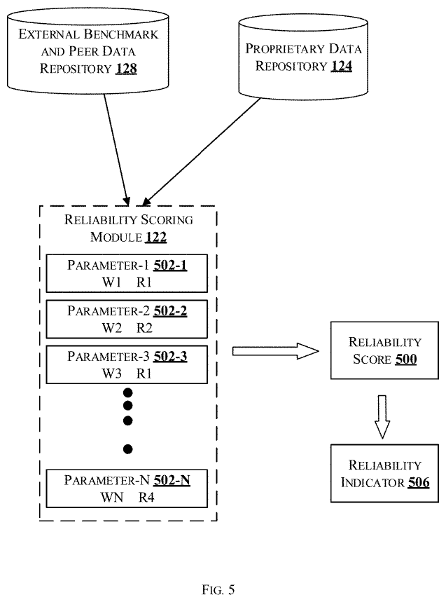

The risk feature module (120) is configured to retrieve the proprietary risk information related to the selected risk feature interface (104) from the proprietary data repository (124). The superimposing module (118) is configured to retrieve the relevant risk information related to the selected risk feature interface (104) from the external benchmark and peer data repository (128). The RAS (102) accesses the proprietary data repository (124) and the external benchmark and peer data repository (128) for the risk feature module (120) to retrieve the relevant information. As illustrated in FIG. 4, the risk management client application (126) and the risk management master application (130) respectively interacts with the client data management module (106) and the external data management module (108) via the network (110) for respectively accessing the proprietary data repository (124) and the external benchmark and peer data repository (128). In one embodiment, the risk management master application (130) enables the authorized users of the RAS (102) to update/modify the external benchmark and peer data repository (128) with the benchmark and/or peer risk information.

The external data management module (108) may comprise an identity manager-A (402) to uniquely identify the authorized users of the RAS (102) logged in via the risk management master application (130) using a unique identity (ID). The risk management master application (130) may access or update the data in the benchmark and peer data repository (128) via an application programmable interface (API) layer (404). In one embodiment, the API layer (404) of the external data management module (108) may access external databases (132-1, 132-2, 132-3) via an external API (406).

The risk management client application (126) enables the authorized users of the organization to access and update the organization's proprietary data repository (124) with proprietary risk information. The client data management module (106) comprises an identity manager-B (410) to uniquely identify the authorized users of the enterprise logged in via the risk management client application (126) using unique identity (ID). The risk management client application (126) may also access or update the data in the proprietary data repository (124) via API layer (412).

The risk feature module (120) retrieves the proprietary risk information (or data records) related to the selected risk feature interface (104) from the proprietary data repository (124) based on the one or more search criteria. The superimposing module (118) is configured to retrieve the relevant risk information (or data records) related to the selected risk feature interface from the external benchmark and peer data repository (128) based on the one or more search criteria and meaningfully compare or overlay the benchmark information onto the proprietary risk information to determine the risk assessment of the risk feature interface (104). The feature interface module (116) further displays the improved risk assessment, determined by simultaneously superimposing the benchmark and/or peer risk information onto the proprietary risk information, on the user device (103). The reliability scoring module (122) is configured to determine the reliability score of the risk assessment and provide a reliability indicator for the determined reliability score.

FIG. 5 illustrates an exemplary representation of reliability scoring module (122) in accordance with an embodiment of the present disclosure. The reliability scoring module (122) is interactively coupled with the proprietary data repository (124) and the external benchmark and peer data repository (128). The reliability scoring module (122) determines the number of data records considered or processed for feature outcome generation, identifies the quality of the data records defined by the data management team at the time of data updation, and identifies the source of the data record. Further, the reliability scoring module (122) determines the reliability score (500) for the risk assessment using one or more defined parameters (502-1, 502-2, 502-3, . . . 502-N (hereinafter collectively referred as parameters 502)) that include but not limited to the number of data records processed, the quality of data records, the source of data records and other parameters such as type of input computation method i.e., manually designed or automated method, and consistency or stability state of the processed data records etc. The value of each defined parameter is classified into one of low, moderate, high and very high category based on the parameter value. Each classified category is assigned with a defined rating (R) according to the parameter type and each parameter is further assigned with a defined weightage score (W). The defined ratings may differ based on the parameter type and category of the parameter value. Further the weightage score can also differ based on the parameter type. In operation, during the risk assessment, the reliability scoring module (122) determines a reliability score (500) indicating the relevance of the processed data records. In one embodiment, the reliability scoring module (122) determines a parameter score for each parameter based on the defined rating (R) obtained by the classification and weightage score (W) of the respective parameter against the processed records obtained based on one or more search criteria from the proprietary data repository (124) and/or the external benchmark and peer data repository (128). The reliability scoring module (122) further computes the reliability score (500) based on the parameter scores for all the defined parameters. The reliability score (500) indicates the relevance of the proprietary risk information used to determine the risk assessment and the benchmark and/or peer risk information, based on the defined set of parameters related to the proprietary risk information.

The reliability score (500) is further transformed into a reliability indicator (506) that is displayed on the user device (103). The reliability indicator (506) is pictorially represented by a four-color scale such as green, yellow, orange or red, that is determined based on the reliability score (500). The reliability indicator (506) may be an indication to illustrate the reliability of the information forming part of the risk assessment in symbolic or graphical format with an overall score or rating. As example, a green reliability indicator denotes a highly reliable underlying information comprising the risk assessment wherein a red indicator signifies the least reliable. In one implementation, the defined parameters, defined rating, and parameter weightage score can be manually changed according to the enterprise requirement.

The reliability scoring module (122) is further configured to automatically update the reliability score (500) based on the real time update in the proprietary risk information, benchmark and/or peer risk information, the one or more search criteria, and feedback to the reliability score (500). As an example, the reliability scoring module (122) determines the reliability score as 86% of a risk assessment corresponding to a risk feature interface, based on the available metrices related to the proprietary risk information and benchmark and/or peer risk information. If the proprietary data repository or the benchmark and peer data repository receive any real time update for the related risk information impacting the aforementioned reliability score, then the reliability scoring module (122) is able to instantly recalculate the reliability score based on the updated risk information metrices and data rating.

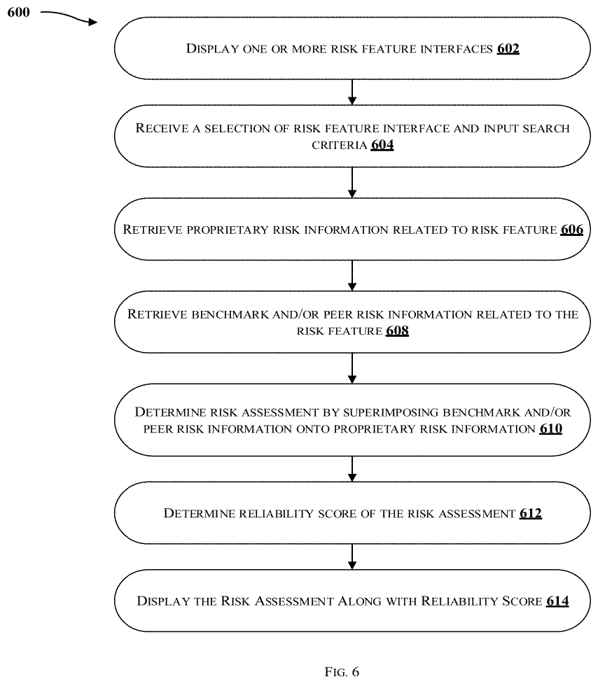

FIG. 6 illustrates a flowchart showing a method for enabling improved risk assessment for an enterprise in accordance with some embodiments of the present disclosure.

As illustrated in FIG. 6, the method (600) comprises one or more blocks implemented by the processor (112) to improve the risk assessment of the enterprise using the RAS (102). The method (600) may be described in the general context of computer executable instructions. Generally, computer executable instructions can include routines, programs, objects, components, data structures, procedures, modules, and functions, which perform specific functions or implement specific abstract data types.

The order in which the method (600) is described is not intended to be construed as a limitation, and any number of the described method blocks can be combined in any order to implement the method (600). Additionally, individual blocks may be deleted from the method (600) without departing from the spirit and scope of the subject matter described herein. Furthermore, the method (600) can be implemented in any suitable hardware, software, firmware, or combination thereof.

At block (602), one or more risk feature interfaces are displayed to the user via user device (103) where each risk feature interface (104) corresponds to a unique representation of risk assessment of the enterprise based on determined combination of risk information of the enterprise.

At block (604), the user selection of at least one risk feature interface is received. In one embodiment, the feature interface module (116) receives the selection of at least one risk feature interface as input from the user. The user may select at least one risk feature interface from the list of risk feature interfaces displayed to the user. In one embodiment, the user may also input one or more filters or selection criteria for the corresponding selected risk feature interface (104). Based on the user input, the RAS (102) may apply the one or more filters or selection criteria and retrieves the risk information related to the selected risk feature interface (104).

At blocks (606 and 608), the risk information related to the selected risk feature interface (104) is retrieved from the proprietary data repository (124) and the external benchmark and peer data repository (128) based on the role of user. The role of the user is determined from the respective user profile (208) stored in the proprietary data repository (126) and may indicate the scope of the data related to the risk feature interfaces that the user is authorized to view. In one example, if the user is head of the organization or chief executive officer (CEO) of the organization, the user is authorized to access all the data of the selected risk feature interfaces (104). In another example, if the user is an employee of the organization, the employee may be authorized to access only a restricted view of the data of the selected risk feature interfaces (104). Based on the role of the user, the feature interface module (116) determines scope of the data that may be used for the risk assessment using the selected risk feature interface. Based on the risk feature interface (104) selected by the user, the related risk information subject to the role of the user is retrieved from the proprietary data repository (124), and if applicable or required risk information is retrieved from the external benchmark and peer data repository (128). In one embodiment, the RAS (102) activates the risk feature module (120) for the risk feature interface (104) selected by the user. In one embodiment, if the selected risk feature interface (104) requires proprietary information of the enterprise, the risk feature module (120) retrieves risk information from the proprietary data repository (124).

In another embodiment, if the selected risk feature interface (104) requires benchmark and/or peer risk information, the risk feature module (120) enables the superimposing module (118) to retrieve risk information from the external benchmark and peer data repository (128). In yet another embodiment, if the selected risk feature interface (104) requires both proprietary information of the enterprise and the benchmark and/or peer information, the risk feature module (120) retrieves risk information from both the proprietary data repository (124) and simultaneously the superimposing module (118) retrieves benchmark information from the external benchmark and peer data repository (128).

For example, if the user selects risk feature interface-1 (104-1) such as a peer analyzer to determine the risk of peer companies, the RAS (102) activates the risk feature module (120). Upon activation, the risk feature module (120) enables the superimposing module (118) to retrieve risk information related to the peers of the same or similar industry from the external benchmark and peer data repository (128). The superimposing module (118) identifies peer companies and retrieves industry key risks, peer risk information, peer risk responses, standard industry risk categories, peer loss data from the external benchmark and peer data repository (128). In another example, if the user selects risk feature interface (104-2) such as a risk portfolio valuer, the risk feature module (120) is activated. The risk feature module (120) retrieves enterprise risk information from the proprietary data repository (124) such as company prioritization framework or risk appetite, the risk register comprising information about risks of the organization, and high rating risks. In yet another example, if the user selects risk feature interface (104-N) such as a residual risk indicator, the risk feature module (120) is activated and retrieves company prioritization framework, the risk register, key risk indicator (KRI) data comprising metrics to track risks on how they are moving over a period and so on from the proprietary data repository (124) and enables the superimposing module (118) to retrieve peer risk information and standard benchmark data for related industry from the external benchmark and peer data repository (128).

At block (610), the risk assessment for the selected risk feature interface (104) is determined. In one embodiment, the superimposing module (118) if required superimposes the risk information retrieved from the external benchmark and peer data repository (128) onto proprietary risk information to determine the risk assessment. The superimposing module (118) identifies at least one risk metric common to both the proprietary risk information and benchmark and/or peer risk information based on the one or more search criteria, retrieves the benchmark and/or peer risk information corresponding to the identified common risk metric, and automatically pushes the determined benchmark and/or peer risk information onto the risk feature interface for displaying in a relevant format. If the risk feature interface selected by the user requires both proprietary risk information and the benchmark and/or peer information for risk analysis, the superimposing module (118) superimposes the data retrieved from the external benchmark and peer data repository (128) onto the risk information retrieved form the proprietary data repository (124) and determines the risk assessment for the risk feature interface. In one example, for the selected risk feature interface (104), the risk feature module (120) enables the superimposing module (118) to map the risk category information of enterprise and the benchmark information and automatically push the identified benchmark and /or peer risk information next to the enterprise risk information in a highly enhanced risk register format to assess the risk for the selected risk feature interface (104). In another example, the RAS (102) can automatically determine one or more updates to the benchmark and/or peer risk information that are mapped to the respective proprietary risk information. Upon determination of any change, the RAS (102) accesses the proprietary risk information represented in the highly enhanced risk register format, by automatically pushing the updated benchmark and/or peer risk information next to the mapped proprietary risk information for improved risk assessment.

In one embodiment, the user may also input various filters for the risk feature interface such as time period, format of display and so on. The super imposing module (118) determines the risk of the enterprise in comparison with the risk of the peer companies by superimposing and mapping and further enables the feature interface module (116) for displaying the determined risk assessment to the user device (103) in one of the different representation as preferred by the user. For the selected risk feature interface (104), the risk assessment may indicate the change i.e., either increase or decrease in risk of the enterprise over a selected period of time compared to the standard change in risk in industry. In one embodiment, the risk assessment may indicate the change i.e., increase or decrease in risk of the enterprise over a selected period of time compared to the peer risk.

At block (612), the reliability score for the improved risk assessment is determined. In one embodiment, the reliability scoring module (122) determines the reliability score (500) of the processed data records used to determine risk assessment or risk understanding to indicate the extent to which the user can rely on the risk assessment or understanding generated by RAS (102). The reliability score (500) may be an indication to illustrate the reliability of the underlying records processed to arrive at the risk assessment in symbolic or graphical format with an overall score or rating. The computed reliability score (500) is further transformed into the reliability indicator (506) that is displayed on the user device (103). The reliability indicator (506) is presented in a four-color scale such as green, yellow, orange or red, that is determined based on the numeric range of reliability score (500).

At block (614), the improved risk assessment and the reliability indicator (506) are displayed in relevant format

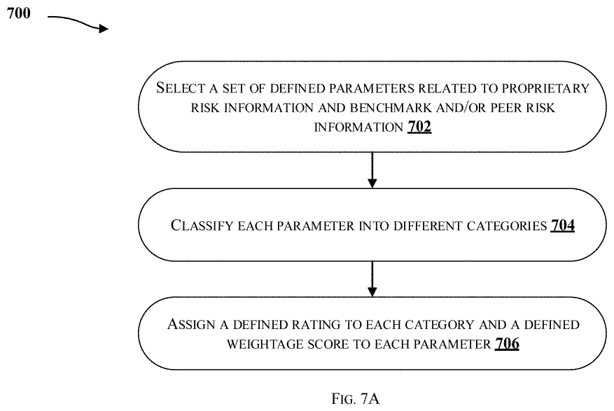

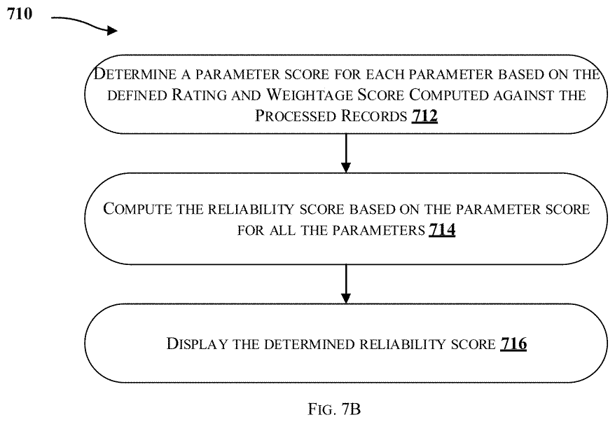

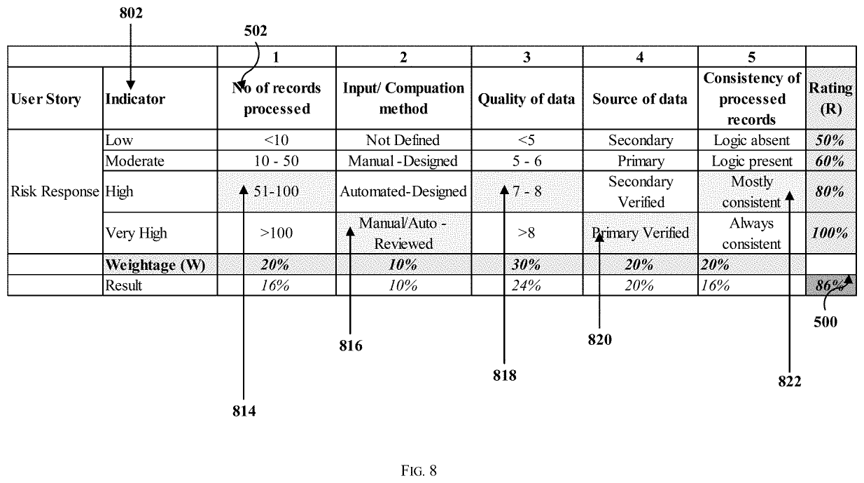

FIG. 7A illustrates a flowchart illustrating a method of defining parameters, rating and weightage for the defined parameters for an enterprise in accordance with some embodiments of the present disclosure;

As illustrated in FIG. 7A, the method (700) comprises one or more blocks implemented by the processor (112) to define the parameters, rating and weightage score for determination of the reliability score of the improved risk assessment of an enterprise using the reliability scoring module (122). The order in which the method (700) is described is not intended to be construed as a limitation, and any number of the described method blocks can be combined in any order to implement the method (700). Additionally, individual blocks may be deleted from the method (700) without departing from the spirit and scope of the subject matter described herein. Furthermore, the method (700) can be implemented in any suitable hardware, software, firmware, or combination thereof.

At block (702), a set of defined parameters related to proprietary risk information and benchmark and/or peer risk information is selected. In one embodiment, the reliability scoring module (122) selects a set of defined parameters that are determined based on certain metrices of the processed proprietary risk information and benchmark and/or peer risk information. The parameters may be one of qualitative and quantitative. The metrices include but not limited to the number of data records considered or processed for risk assessment, quality of the data records defined by the data management team, the source of the data records, type of input computation method, algorithm used to assess the relevance, consistency of processed records etc.

At block (704), the reliability scoring module (122) classifies each defined parameter into different categories based on the parameter value. In one embodiment, the parameter value may be classified into one of low, moderate, high and very high category based on the value of the parameter.

At block (706), each classified category is assigned with a defined rating (R) according to the parameter type and each parameter is further assigned with a defined weightage score (W). The defined ratings may differ based on the parameter type and category of the parameter value. Further the weightage score can also differ based on the parameter type. In one example, if the number of processed records is between 50 and 100, then the 80% rating is defined for the parameter related to the number of processed records. Further, if the computation method is manual then the 60% rating is defined for the parameter related to the computation method for risk assessment. In an analogous approach, the weightage score of one or more parameters are defined based on the importance of the parameter in the process of risk assessment. In one implementation, the defined ratings (R) and the defined weightage scores (W) are adjusted manually based upon the change in the reliability scoring preference of the enterprise.

FIG. 7B illustrates a flowchart showing a method for determining reliability score of the risk assessment for an enterprise in accordance with some embodiments of the present disclosure.

As illustrated in FIG. 7B, the method (710) comprises one or more blocks implemented by the processor (112) to determine the reliability score of the improved risk assessment of an enterprise using the reliability scoring module (122).

The order in which the method (710) is described is not intended to be construed as a limitation, and any number of the described method blocks can be combined in any order to implement the method (710). Additionally, individual blocks may be deleted from the method (710) without departing from the spirit and scope of the subject matter described herein. Furthermore, the method (710) can be implemented in any suitable hardware, software, firmware, or combination thereof.

At block (712), the reliability scoring module (122) determines a parameter score for each parameter based on the defined rating (R) and weightage score (W) of the respective parameter computed against the processed records. The reliability scoring module (122) determines the reliability score (500) indicating the relevance of the processed data records. In one embodiment, the reliability scoring module (122) determines a parameter score for each parameter based on the defined rating (R) obtained by the classification and weightage score (W) of the respective parameter against the processed records obtained based on one or more search criteria from the proprietary data repository (124) and/or the external benchmark and peer data repository (128). The reliability scoring module (122) further computes the reliability score (500) based on the parameter scores for all the defined parameters. The reliability score (500) indicates the relevance of the proprietary risk information used to determine the risk assessment and the benchmark and/or peer risk information, based on the defined set of parameters related to the proprietary risk information.

At block (714), the reliability score (500) is computed based on the parameter scores for all the defined parameters wherein the computed reliability score (500) and is displayed on the user device in desired format as illustrated at block (716). FIG. 8 illustrates an exemplary illustration of calculating reliability score in accordance with an embodiment of the present disclosure. The tabular representation depicts one or more defined parameters (502), where the no of defined parameters may vary based upon the requirement of client. In the example, five different parameters (1, 2, 3, 4, and 5) such as number of records processed, input/computation method, quality of data indicator, source of data, and consistency or stability state of processed records etc. have been mentioned. Each defined parameter may be qualitative or quantitative.

As illustrated, indicator (802) denotes the one or more different categories such as low, moderate, high, and very high, where for each category of indicator a respective rating (R) is defined. Further, for each defined parameter (502), a weightage score (W) is assigned. In the cited example, the rating (R) has been defined as 50%, 60%, 80%, and 100% for the categories of low, moderate, high, and very high respectively. The weightage score (W) has been defined as 20%, 10%, 30%, 20%, and 20% for the mentioned five parameters (1, 2, 3, 4, and 5) respectively. In the process of risk assessment, the RAS (102) determines the values (814, 816, 818, 820, 822) of aforementioned five parameters (502) as described below i.e.

| | |
|---|---|
| No of records processed | 85 (814) |
| Input/computation method | Manual/Auto |
| | reviewed (816) |
| Quality of data | 7 (818) |
| Source of data | Primary Verified |
| | (820) |
| Consistency or stability | Mostly consistent |
| state of processed records | (822) |

Further, the values of defined parameters are compared against the defined categories (802) to determine the corresponding rating (W) of the parameter value. A parameter score of each parameter is determined by calculating the weightage score (W) percentage of the determined rating (R) of the respective parameter i.e. the rating for parameter 1 (no of processed records) has been determined as 80% as the no of records is 85 (814), and the weightage score of parameter 1 is 20%, so the parameter score for parameter 1 is 16% (i.e. 20% of 80%). In analogous approach, all the parameter scores of parameters 2, 3, 4, and 5 are determined as 10%, 24%, 20%, and 16%. Furthermore, the reliability score (500) is determined by accumulating all the parameters' scores which results into 86%.

In an alternative embodiment, the RAS (102) can automatically determine a low reliability score for the risk assessment and investigate the underlying data responsible for such low reliability score. Upon investigation, the RAS (102) automatically downgrade the data rating of aforementioned underlying data and re-evaluates the risk assessment score. Thus, the RAS (102) can learn from data, automate repetitive tasks and improve data quality by implementing machine learning (ML). Usually, Machine Learning (ML) is exposed to set of information, where the respective system draws conclusions from such information and implement those conclusions to similar situations without having any explicit programs for such execution. Data quality of an enterprise is dependent on several factors such as accuracy, reliability, relevance, timeliness etc. The RAS (102) can further improve data quality by receiving the semi-automated feedback from the user of the RAS (102) where the users believe that the respective risk assessment and the reliability indicator are not accurate as per the expectation. The embedded Machine Learning (ML) module receives such feedbacks and automatically improves the data quality by analyzing the historical data and implementing the suitable solution derived from the historical data. The ML module further upgrade the system memory with the new learning in the form of new rule so that the new rule can be applied on the next data set the system reviews. The ML module works in three different phases such as error detection, correction, and prevention. The advantage of ML is that a system always evolves with the new data experiences.

As an example, the user of RAS (102) can provide feedback on the received risk assessment and reliability indicator. The RAS (102) needs to reconcile all such feedbacks manually as the feedbacks may be in unstructured forms, where such reconciliation process is labor-intensive and prone to error. The ML module enables the RAS (102) to reduce the processing time and make the data quality improvement process automatic. The ML module scans each feedback, processes the feedback content, and compares the problem with the historical content. Upon comparing, the ML module derives the most suitable solution for the received problem, proposes alternatives and/or implements or suggests solution to improve data quality. The ML module further updates the memory with the new set of problems and respective solutions for future reference.

In one embodiment, the RAS (102) automatically updates the reliability score for improved risk assessment based on the real time proprietary risk information, benchmark and/or peer risk information, one or more search criteria, and feedback to the previous reliability score. As an example, a user can select one or more risk feature interfaces along with one or more search criteria to inquire about one or more risk assessments. The RAS (102) determines the improved risk assessment for the respective risk feature interfaces based on the available proprietary risk information and benchmark and/or peer risk information and calculates the reliability score based on the metrices related to the improved risk assessment. The proprietary data repository and benchmark and peer data repository both are updated by the respective data management team. Upon determining change in the respective information of the proprietary data repository and benchmark and peer data repository, the RAS (102) further re-evaluates the reliability score and displays the same on the user device. In another example, the RAS (102) can perform re-evaluation upon determining change in search criteria or change in feedback repository for reliability score etc.

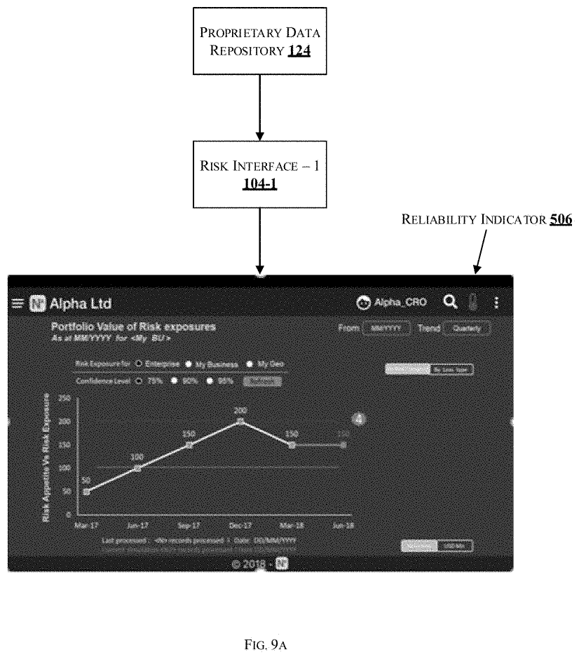

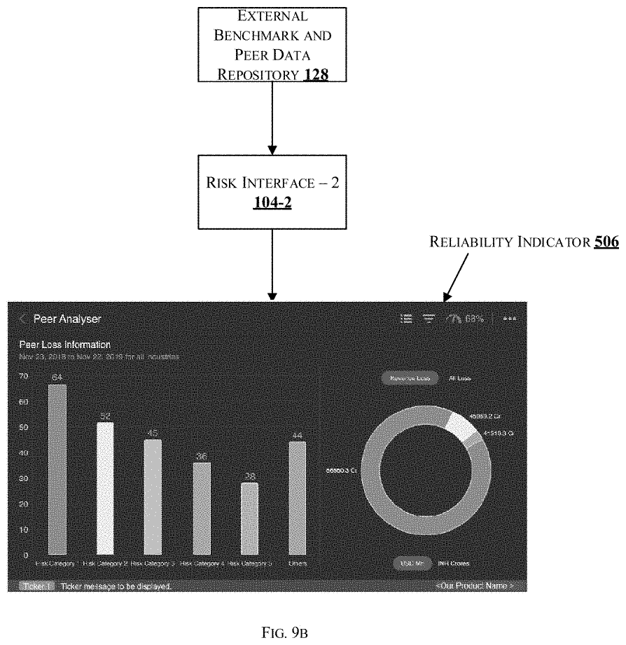

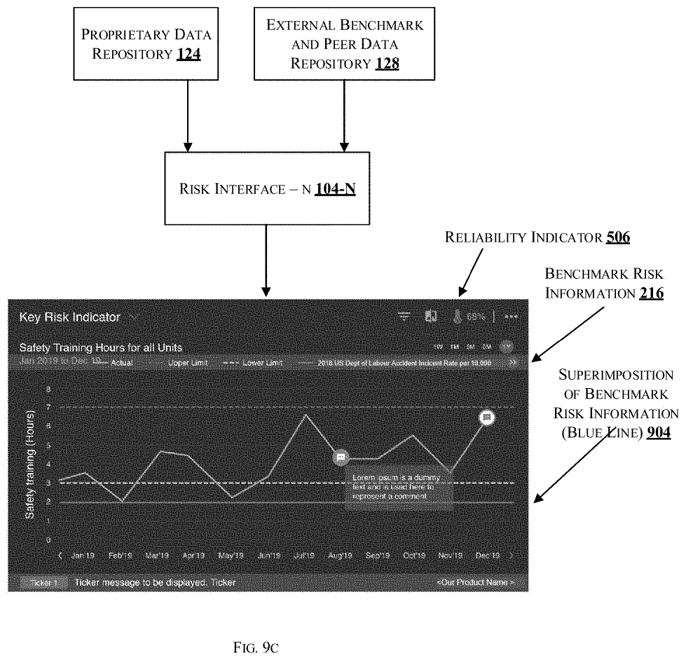

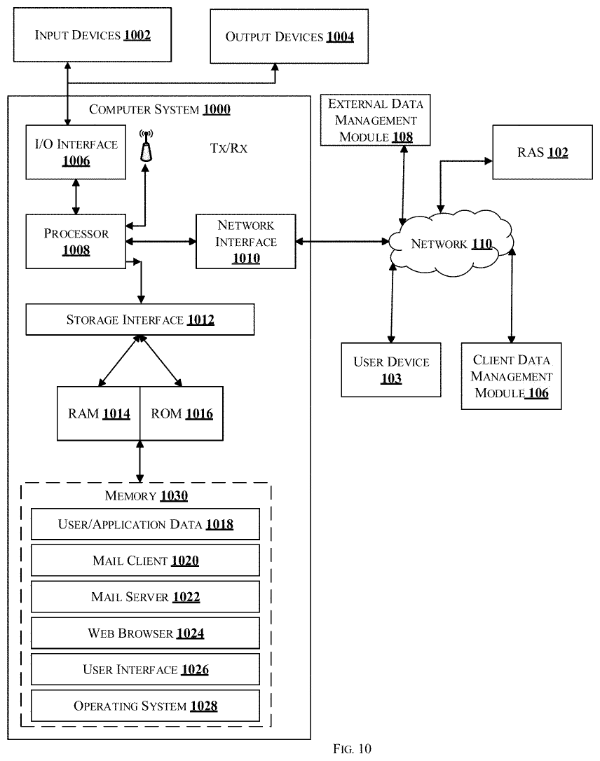

At block (716), the determined reliability score is displayed. In one embodiment, the feature interface module (116) presents the improved risk understanding and the reliability score to the user in the relevant format. In one example, for selection of the risk feature interface-1 (104-1), an improved risk assessment is represented as shown in FIG. 9A to indicate risk exposure plotted against upper & lower limits for a time period. The horizontal line below the upper limit i.e., risk appetite indicates risk tolerance as shown in FIG. 9A. In another example, for a risk feature interface-2 (104-2), an improved risk assessment is represented as shown in FIG. 9B. The peer loss information is represented for various risk categories including human resources, supply chain, pharma regulatory and other risks for selected revenue losses. In yet another example, if the user selects risk feature interface-N (104-N) along with the desired filters for example, time period, type of display format etc., the feature interface module (116) drill downs to a risk assessment based on selection criteria as represented in FIG. 9C. FIG. 9C illustrates superimposition of the external benchmark information onto the proprietary risk information of the enterprise. In an example for the risk assessment of risk feature interface-N (104-N), the feature interface module (116) presents reliability indicator (506) in green colour and the blue line represent the superimposition (904) of the external benchmark information (216) that is displayed as “The legend (i.e. 2018 US Dept of Labour accident incident rate per 10,000)” as illustrated in FIG. 9C. The reliability indicator (506) in one example can be presented as colour indicators, wherein each colour is defined to illustrate that the risk assessment is one of less reliable, more reliable and moderate to rely. In another example, the reliability indicator (506) can be presented as a progress score or a combination of colour indicator and progress score to illustrate reliability of the risk assessment, wherein the progress score is indicating the reliability score. In yet another example, the reliability indicator (506) that is presented to the user, display a pop up indicating one or more of the parameters used for determination of reliability score (500) of the risk assessment when the user touches on the reliability indicator (506) presented on the display screen of the user device (103).

In an example, when the user i.e., authorized person of the enterprise wishes to know or analyze the risk of the enterprise, the user interacts with the RAS (102) via the user device (103). The RAS (102) receives the user credentials and validates the received credentials based on the user profiles (208) stored in the memory (114) of RAS (102). Upon validation, the feature interface module (116) displays all the risk feature interfaces on the display screen of the user device (103). If the user wishes to know the residual risk of the enterprise i.e., to preview in which direction the risk is moving/changing over a period of time, the user may select the risk feature interface-N (104-N) along with desired filters such as period of time as financial year 2019-2020, format of display of reliability as color indicator. The risk feature module (120) corresponding to risk feature interface-N (104-N) is activated. The risk feature module (120) retrieves company prioritization framework, the risk register, Key risk indicator (KRI) data comprising metrics to track risks on how they are moving over a period 2019-2020 and so on from the proprietary data repository (124). Further, the risk feature module (120) enables the superimposing module (118) to retrieve standard benchmark data for related industry from the external benchmark and peer data repository (128). The superimposing module (118) superimposes the risk information retrieved from the external benchmark and peer data repository (128) onto the proprietary data repository (124) to determine the improved risk assessment for the risk feature interface-N (104-N) as displayed in FIG. 9C. The reliability scoring module (122) determines the reliability score (500) of the risk assessment using the number of data records processed, quality of data records, source of data records and other parameters such as type of input computation method i.e., manually designed or automated method, where the reliability score (500) is further transformed to the reliability indicator (506). Based on user input of desired filter of display format of reliability as color indicator, for example red colored indicator, illustrating the reliability of 50 percent or less.

The ability or intelligence of the system to retrieve and use combination of proprietary risk information and benchmark information enhances the quality of the risk information provided. The RAS thus provides a common platform along with an external benchmark and peer data repository comprising the external data accumulated from open sources, paid sources, input from KPO etc. and stored in a structured manner to make such data easily accessible. The accumulated data is further analyzed and rated based upon the quality of data so that the superimposition can function with the highly rated data only. The RAS further enables one or more enterprises to plug-in to the external benchmark and peer data repository without accessing the enterprises' internal information thereby securing data from being compromised. Also, the enterprise can access the required external benchmark and peer information in just-in-time manner so that the access-time is reduced in a great extent.

The RAS also performs real time updates to the external benchmark and peer data repository enabling the plugged-in enterprise users to receive the most recent benchmark and peer risk information superimposed onto the proprietary risk information. Further, the enterprise can prevent the overhead of storing and maintaining the external information which in turn facilitates in reduction of memory consumption as well as the computing efficiency of the enterprise system. Therefore, the present disclosure provides an automated, robust, highly scalable, time-efficient platform to the one or more enterprises for receiving the external and peer risk information in a hassle-free manner.

FIG. 10 illustrates a block diagram of an exemplary computer system for implementing embodiments consistent with the present disclosure.

In an embodiment, the computer system (1000) may be a system for improving risk assessment (102), which is used for improving risk assessment by providing external data. The computer system (1000) may include a central processing unit (“CPU” or “processor”) (1008). The processor (1008) may comprise at least one data processor for executing program components for executing user or system-generated business processes. The processor (1008) may include specialized processing units such as integrated system (bus) controllers, memory management control units, floating point units, graphics processing units, digital signal processing units, etc.

The processor (1008) may be disposed in communication with one or more input/output (I/O) devices (1002 and 1004) via I/O interface (1006). The I/O interface (1006) may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface (1006), the computer system (1000) may communicate with one or more I/O devices (1002 and 1004). In some implementations, the processor (1008) may be disposed in communication with a communication network (110) via a network interface (1010). The network interface (1010) may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface (1010) and the network (110), the computer system (1000) may be connected to client data management module (106), the RAS (102) and the user device (103).

The network (110) can be implemented as one of the several types of networks, such as intranet or any such wireless network interfaces. The network (110) may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network (110) may include a variety of network devices, including routers, bridges, servers, computing devices, storage devices, etc.

In some embodiments, the processor (1008) may be disposed in communication with a memory (1030) e.g., RAM (1014), and ROM (1016), etc. as shown in FIG. 10, via a storage interface (1012). The storage interface (1012) may connect to memory (1030) including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (1030) may store a collection of program or database components, including, without limitation, user/application, an operating system (1028), a web browser (1024), a mail client (1020), a mail server (1022), a user interface (1026), and the like. In some embodiments, computer system (1000) may store user/application data (1018), such as the data, variables, records, etc. as described in this invention. Such databases may be implemented as fault-tolerant, relational, scalable, secure databases such as Oracle or Sybase.

The operating system (1028) may facilitate resource management and operation of the computer system (1000). Examples of operating systems include, without limitation, Apple Macintosh™ OS X™, UNIX™, Unix-like system distributions (e.g., Berkeley Software Distribution (BSD), FreeBSD™, Net BSD™, Open BSD™, etc.), Linux distributions (e.g., Red Hat™, Ubuntu™, K-Ubuntu™, etc.), International Business Machines (IBM™) OS/2 ™, Microsoft Windows™ (XP™, Vista/⅞, etc.), Apple iOS™, Google Android™, Blackberry™ Operating System (OS), or the like. A user interface may facilitate display, execution, interaction, manipulation, or operation of program components through textual or graphical facilities. For example, user interfaces may provide computer interaction interface elements on a display system operatively connected to the computer system (1000), such as cursors, icons, check boxes, menus, windows, widgets, etc. Graphical User Interfaces (GUIs) may be employed, including, without limitation, Apple™ Macintosh™ operating systems' Aqua™, IBM™ OS/2™, Microsoft™ Windows™ (e.g., Aero, Metro, etc.), Unix X-Windows™, web interface libraries (e.g., ActiveX, Java, JavaScript, AJAX, HTML, Adobe Flash, etc.), or the like.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

What is claimed is:

1. A method of improving risk assessment for an enterprise, comprising:
receiving, by a risk management system, a selection of at least one risk feature interface and one or more search criteria associated with the at least one selected risk feature interface as input from a user;
retrieving, by the risk management system, proprietary risk information, related to at least one selected risk feature interface corresponding to the one or more search criteria;
retrieving, by the risk management system, benchmark and/or peer risk information, related to the at least one selected risk feature interface corresponding to the one or more search criteria;
determining, by the risk management system, risk assessment, by simultaneously superimposing benchmark and/or peer risk information onto the proprietary risk information; and
contemporaneously displaying, by the risk management system, the risk assessment determined based on the superimposition.

2. The method as claimed in claim 1, further comprising managing one or more risk feature interfaces, wherein managing comprises steps of:
determining the one or more risk feature interfaces (104), wherein each risk feature interface corresponds to a unique representation of risk assessment of the enterprise based on predetermined combination of risk information of the enterprise; and
displaying the one or more determined risk feature interfaces (104) on the user device for selection by the user.

3. The method as claimed in claim 1, wherein the proprietary risk information comprises risk information and a plurality of risk metrics associated with the enterprise, and wherein the benchmark and/or peer risk information comprises at least benchmark information related to various risk and peer risk and response information associated with plurality of peer enterprises.

4. The method as claimed in claim 1, wherein the superimposing comprises steps of:
identifying at least one risk metric common to both the proprietary risk information and benchmark and/or peer risk information obtained based on the one or more search criteria;
retrieving the benchmark and/or peer information corresponding to the identified at least one common risk metric; and
automatically pushing the determined benchmark and/or peer information onto the risk feature interface for displaying in a relevant format along with the proprietary risk information in real time for improved risk assessment.

5. The method as claimed in claim 1, further comprising:
determining a reliability score indicative of relevance of data records comprising the proprietary risk information used to determine the risk assessment and benchmark and/or peer risk information, based on a set of defined parameters related to the proprietary risk information or benchmark and/or peer risk information obtained based on the one or more search criteria, wherein the set of defined parameters include but not limited to count of the data records, input method of data records, quality of data, source of data, and consistency of processed data records; and
automatically updating the reliability score for improved risk assessment based on the proprietary risk information, benchmark and/or peer risk information, the one or more search criteria, and feedback to the reliability score.

6. The method as claimed in claim 5, wherein determining the reliability score comprising:
classifying each parameter value into one of low, moderate, high and very high categories based on the parameter value, wherein each of the categories is assigned with a defined rating (R), and each parameter is assigned with a defined weightage score (W);
determining -a parameter score for each of the defined parameter based on the defined rating (R) of the respective parameter obtained by the classification and respective defined weightage score (W) of the parameter against the processed data records; and
computing the reliability score based on the parameter score for all the defined parameters.

7. The method as claimed in claim 1, further comprising:
determining one or more updates to the benchmark and/or peer risk information mapped to the proprietary risk information; and
dynamically superimposing onto the proprietary risk information by automatically pushing the updated benchmark and/or peer risk information next to the mapped propriety risk information for optimized risk assessment.

8. A system for improving risk assessment for an enterprise, the system comprising:
a processor and a user device coupled with the processor;
one or more risk feature interfaces coupled to the processor;
a memory communicatively coupled with the processor, wherein the memory stores processor-executable instructions, which on execution, cause the processor to:
receive a selection of at least one risk feature interface and one or more search criteria associated with the at least one selected risk feature interface as input from a user;
retrieve proprietary risk information, related to at least one selected risk feature interface corresponding to the one or more search criteria;
retrieve benchmark and/or peer risk information, related to the at least one selected risk feature interface corresponding to the one or more search criteria;
determine an improved risk assessment, by simultaneously superimposing benchmark and/or peer risk information onto the proprietary risk information; and
contemporaneously display the improved risk assessment determined based on the superimposition.

9. The system as claimed in claim 8, wherein the processor is further configured to manage one or more risk feature interfaces, by:
determining the one or more risk feature interfaces, wherein each risk feature interface corresponds to a unique representation for improved risk assessment of the enterprise based on a determined combination of risk information of the enterprise accessible by the user based on access policy corresponding to the role of the user; and
displaying the one or more determined risk feature interfaces on the user device for selection by the user.

10. The system as claimed in claim 8, wherein the proprietary risk information comprises risk information and a plurality of proprietary risk metrics associated with the enterprise, and wherein the benchmark and/or peer risk information comprises at least benchmark information related to various risk and peer risk and response information associated with plurality of peer enterprises.

11. The system as claimed in claim 8, further comprises a proprietary data repository for storing the proprietary risk information, and a client data management module coupled with the proprietary data repository and configured to manage and update the proprietary risk information in the proprietary data repository.

12. The system as claimed in claim 8, further comprises an external risk benchmark and peer data repository for storing the benchmark and/or peer risk information, and an external data management module coupled with the external benchmark and peer data repository and configured to manage and update the benchmark and/or peer risk information in the external benchmark and peer data repository.

13. The system as claimed in claim 12, wherein the external data management module receives feeds of the benchmark, peer risk information from one of public databases, subscribed databases and input data provided by a Knowledge Process Organization.

14. The system as claimed in claim 8, wherein the processor is configured to superimpose the benchmark and/or peer risk information onto the proprietary risk information, by:
identifying at least one risk metric common to both the proprietary risk information and benchmark and/or peer risk information obtained based on the one or more search criteria;
retrieving the benchmark and/or peer information corresponding to the identified at least one common risk metric; and
automatically pushing the determined benchmark and/or peer information onto the risk feature interface for display in a relevant format along with the proprietary risk information in real time for improved risk assessment.

15. The system as claimed in claim 8, wherein the processor is further configured to:
determine a reliability score indicative of relevance of data records comprising the proprietary risk information used to determine risk assessment and benchmark and/or peer risk information, based on a set of defined parameters related to the proprietary risk information and benchmark and/or peer risk information obtained based on the one or more search criteria, wherein the set of defined parameters include but not limited to count of the data records, input method of data records, quality of data, source of data and consistency of processed data records; and
automatically update the reliability score for risk assessment based on the real time proprietary risk information, benchmark and/or peer risk information, the one or more search criteria, and feedback to the reliability score.

16. The system as claimed in claim 15, wherein the processor is configured to determine the reliability score by:
classifying each parameter value into one of low, moderate, high and very high categories based on the parameter value, wherein each of the categories is assigned with a defined rating (R), and each parameter is assigned with a defined weightage score (W);
determining a parameter score for each of the defined parameter based on the defined rating of the respective parameter obtained by the classification and respective defined weightage score of the parameter against the processed data records; and
computing the reliability score based on the parameter score for all the defined parameters.

17. The system as claimed in claim 8, wherein the processor is further configured to:
determine one or more updates to the benchmark and/or peer risk information mapped to the proprietary risk information; and
dynamically superimpose onto the proprietary risk information by automatically pushing the updated benchmark and/or peer risk information next to the mapped propriety risk information for optimized risk assessment.

18. A non-transitory computer-readable storage medium that stores instructions executable by a processor that, in response to execution of the instructions, cause the processor to perform operations comprising:
receiving a selection of at least one risk feature interface and one or more search criteria of the at least one selected risk feature interface as input from a user;
retrieving proprietary risk information, related to at least one selected risk feature interface corresponding to the one or more search criteria;
retrieving benchmark and/or peer risk information, related to the at least one selected risk feature interface corresponding to the one or more search criteria;
determining improved risk assessment, by simultaneously superimposing benchmark and/or peer risk information onto the proprietary risk information; and
contemporaneously displaying the improved risk assessment determined based on the superimposition.

19. The non-transitory computer-readable storage medium of claim 18, wherein the operations further cause the processor to manage the one or more risk feature interfaces by:
determining the one or more risk feature interfaces, wherein each risk feature interface corresponds to a unique representation for improved risk assessment of the enterprise based on a determined combination of risk information of the enterprise accessible by the user based on access policy corresponding to the role of the user; and
displaying the one or more determined risk feature interfaces on the user device for selection by the user.

20. The non-transitory computer-readable storage medium of claim 18, wherein the operation further causes the processor to receive feeds of the benchmark, peer risk information from one of public databases, subscribed databases and input data provided by a Knowledge Process Organization.

21. The non-transitory computer-readable storage medium of claim 18, wherein the operation to superimpose causes the processor to:
identify at least one risk metric common to both the proprietary risk information and benchmark and/or peer risk information obtained based on the one or more search criteria;
retrieve the benchmark and/or peer information corresponding to the identified at least one common risk metric; and
automatically push the determined benchmark and/or peer information onto the risk feature interface for display in a relevant format along with the proprietary risk information in real time for improved risk assessment.

22. The non-transitory computer-readable storage medium of claim 18, further cause the processor to perform operations comprising:
determining a reliability score indicative of relevance of data records comprising the proprietary risk information used to determine risk assessment and benchmark and/or peer risk information, based on a set of defined parameters related to the proprietary risk information and benchmark and/or peer risk information obtained based on the one or more search criteria, wherein the set of defined parameters include but not limited to count of data records, input method of the data records, quality of data, source of data and consistency of processed data records; and
automatically updating the reliability score for improved risk assessment based on the real time proprietary risk information, benchmark and/or peer risk information, the one or more search criteria, and feedback to the reliability score.

23. The non-transitory computer-readable storage medium of claim 22, wherein the operation to determine the reliability score cause the processor to:
classify each parameter value into one of low, moderate, high and very high categories based on the parameter value, wherein each of the categories is assigned with a defined rating, and each parameter is assigned with a defined weightage score;
determine a parameter score for each of the defined parameter based on the defined rating of the respective parameter obtained by the classification and respective defined weightage score of the parameter; and
compute the reliability score based on the parameter score for all the defined parameters.

24. The non-transitory computer-readable storage medium of claim 18, further cause the processor to perform operations comprising:
determining one or more updates to the benchmark and/or peer risk information mapped to the proprietary risk information; and
dynamically superimposing onto the proprietary risk information by automatically pushing the updated benchmark and/or peer risk information next to the mapped propriety risk information for optimized risk assessment.
